(19) United States
(12) Patent Application Publication
(10) Pub. No.: US 2004/0240771 A1
(43) Pub. Date: Dec. 2, 2004

(54) Device and method for receiving, processing and transmitting optical an electrical signals and method for manufacturing such a device

(76) Inventor: Alfred Driessen, Hengelo (NL)

Correspondence Address: John W McIlvaine, 700 Koppers Building, 436 Seventh Avenue, Pittsburgh, PA, 15219-1818, US

(21) Appl. No.: 10/477,655

(22) PCT Filed: May 14, 2002
(86) PCT No.: PCT/NL02/00309

(30) Foreign Application Priority Data
May 14, 2001 (NL) 1018063

(51) Int. Cl. G02B 6/12

(52) U.S. Cl. 385/14; 385/11

(57) ABSTRACT

The invention relates to a device for receiving, processing and transmitting optical and electrical signals, comprising: an optical or processing optical signals; a connection for optically coupling an optical wave-guide such as a glass fibre to the optical circuit; at least one opto-electrical converter for converting an optical signal into an electrical signal, which opto-electrical converter is coupled optically to the optical circuit and which opto-electrical converter can be coupled electrically to an electronic appliance, and at least one electro-optical converter for converting an electrical signal into an optical signal, which electro-optical converter is coupled optically to the optical circuit. The invention also relates to a method for manufacturing such a device.

The invention relates to a device for receiving, processing and transmitting optical and electrical signals, comprising: an optical circuit for processing optical signals; a connection for optically coupling an optical wave-guide such as a glass fibre to the optical circuit; at least one opto-electrical converter for converting an optical signal into an electrical signal, which opto-electrical converter is coupled optically to the optical circuit and which opto-electrical converter can be coupled electrically to an electronic appliance, and at least one electro-optical converter for converting an electrical signal into an optical signal, which electro-optical converter is coupled optically to the optical circuit. The invention also relates to a method for manufacturing such a device. The invention further relates to a method for receiving, processing and transmitting optical signals.

With the growing use of Internet, increasing telephone traffic and due to developments such as ‘TV on demand’, the demand for broadband bi-directional data communication has increased enormously. In order to meet this demand optical glass fibre networks are being installed at great speed. At this moment glass fibre technology is the most suitable for long-distance communication because of the large amount of data which can be transmitted over a glass fibre network with few losses and at high speed. Use is made herein of WDM (wavelength division multiplexing) to enable parallel transmission of a large number of signals over a single glass fibre.

Transceivers are of vital importance in optical communication. They form the important link between an electronic appliance (such as a computer, telephones or audiovisual equipment) and an optical glass fibre network. An optical transceiver combines the functions of transmitter and receiver in a single apparatus. The transceiver converts electrical signals coming from an electronic appliance into optical signals and, after an optional processing, guides them into a glass fibre. After an optional processing, optical signals coming from the glass fibre are converted into electrical signals and guided to the electronic appliance. A typical optical transceiver uses a PIN or photo diode coupled to an amplifier to convert an optical signal into an electrical signal, and a laser diode to generate an optical signal. At higher transmission speeds or in the case of a plurality of independent data channels use is made of one or more fast modulators, which each provide a part, usually falling within a determined wavelength range, of the continuous light from a light source, in these cases usually a laser diode or LED, with a code.

The European patent application EP 0 141 771 describes an optical resonator with a resonator ring in the form of a monomode fibre, as well as the application of such a resonator. The closed resonator ring is constructed from a polarization-maintaining monomode fibre which is suitable for throughfeed of optical signals. Such an optical resonator is relatively expensive and bulky.

Optical transceivers are relatively expensive and have therefore been used heretofore mainly in professional environments. The most important obstacle for so-called fibre-to-the-home systems is this high price of the required transceiver. It is therefore usual to have the glass fibre run to a node to which a plurality of users is connected by means of metal cables: a so-called fibre-to-the-node system. In this manner the high cost of a transceiver is shared, although this is at the expense of the transmission speed.

In summary, it can be said that there is a great need for relatively inexpensive, compact and fast transceivers which are able to handle a large data flow and are thereby suitable for instance for a fibre-to-the-home system. These transceivers can preferably also perform multiplexing and de-multiplexing tasks. The object of the present invention is to provide such a transceiver.

The invention provides for this purpose a device for receiving, processing and transmitting optical and electrical signals of the type stated in the preamble, characterized in that the optical circuit is an integrated circuit comprising a plurality of optical ring resonators. The term signal is here understood to mean an optionally coded stream of light or electrical current. The term optical does not exclude wavelengths outside the visible spectrum. The opto-electrical converter can be a photo diode. The electro-optical converter can for instance be a directly modulated light source, for instance a laser diode or LED, or a modulator which provides (continuous) light coming from a light source with a code. The advantage of such a device is the very limited number of optical components required. This implies a cost reduction relative to the known equipment. The device preferably comprises at least one passive optical ring resonator and at least one active optical ring resonator. These passive and active ring resonators can together perform all the required tasks, such as wavelength-dependent filtering, switching, modulating, multiplexing and de-multiplexing.

A preferred embodiment of a device according to the invention also comprises: at least one polarization splitter and at least one polarization converter. For processing of optical signals with a polarization direction which is random and changes through time, optical ring resonators will then suffice which are optimized for one polarization direction, which is a great advantage from a design engineering viewpoint.

The invention also provides a method for manufacturing a device according to the invention, characterized in that the optical circuit is manufactured in at least partly integrated manner by means of a planar technology. Planar technology is here understood to mean a technique common in the microtechnological field, also known as ‘microsystem technology’, such as thin-film deposition, diffusion, wet chemical etching, ‘reactive ion etching’, whether or not in combination with a lithographic or abrasive technique. The advantage hereof is the possibility of integrated manufacture of one or more devices, which means a considerable cost reduction, particularly with larger numbers. In addition, very compact devices can be manufactured in this way.

The invention further provides a method for receiving, processing and transmitting optical and electrical signals, comprising the steps of:

A. guiding a first optical signal from an optical wave-guide into an optical circuit;

B. splitting the first optical signal into a number of first optical part-signals, each falling within a given wavelength range, by means of a number of first passive optical ring resonators;

C. separately switching at least one of the first optical part-signals by means of a number of first active optical ring resonators;

D. converting at least one of the switched first optical part-signals into a first electrical signal by means of an opto-electrical converter;

E. generating a second optical signal;

F. splitting the second optical signal into a number of second optical part-signals, each falling within a given wavelength range, by means of a number of second passive optical ring resonators;

G. separately modulating at least one of the second optical part-signals by a second electrical signal by means of a number of second active optical ring resonators;

H. combining at least one of the modulated second optical part-signals to form a third optical signal by means of a number of third passive optical ring resonators, and

I. guiding the third optical signal into the optical wave-guide. The second optical signal is for instance continuous light coming from a laser diode or LED which is split into part-signals by the second passive optical ring resonators, whereafter the part-signals are individually provided with codes by means of the second active optical ring resonators.

It is also possible to replace steps E, F and G by:

Q. generating at least one second optical signal, and

R. modulating the second optical signal by a second electrical signal. Modulation of the second optical signal can for instance take place by directly modulating a light source by an electrical signal from an electronic appliance.

All required tasks, such as wavelength-dependent filtering, switching, modulating, multiplexing and de-multiplexing can thus be performed by means of a very limited number of optical components.

The method preferably also comprises the steps of:

X. splitting the first optical signal into two polarized optical part-signals by means of a polarization splitter, and

Y. converting the polarization direction of one of the two polarized optical part-signals by means of a polarization converter.

In this manner an incoming optical signal with a polarization direction which is random and changes through time can be converted into two part-signals with a single polarization direction. The ring resonators can then be optimized for this single polarization direction. This also means a further reduction in the number of types of optical component required.

The invention is elucidated in the following on the basis of a non-limitative embodiment of a device according to the invention.

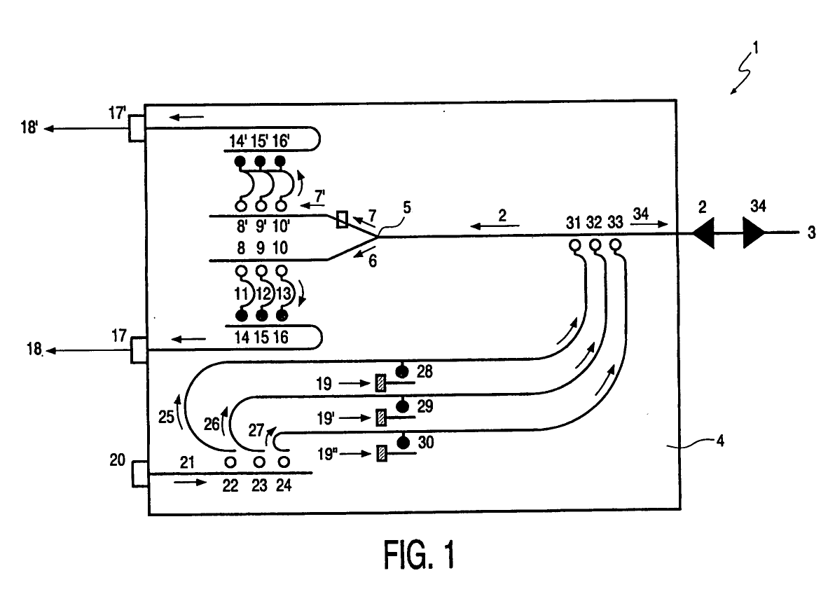

FIG. 1 shows schematically for this purpose a preferred embodiment of a device according to the invention.

FIG. 1 shows a device 1 according to the invention for receiving, processing and transmitting optical and electrical signals. A first optical signal 2 coming from a glass fibre 3 is guided into an optical circuit 4. The first optical signal 2 is split by means of polarization splitter 5 into two orthogonally polarized optical part-signals 6,7. By means of a number of first passive optical ring resonators 8,9,10 the first polarized optical part-signal 6 is split into a number of first optical part-signals 11,12,13, each falling within a given wavelength range. The number of wavelength ranges, three in this embodiment, can be much greater in practice, for instance a hundred or more. The first optical part-signals 11,12,13 are separately switched by means of a number of first active optical ring resonators 14,15,16 and converted by means of a photo diode 17 into a first electrical signal 18 which is guided to an electronic appliance (not shown). The polarization direction of second polarized optical part-signal 7 is rotated through 90° by means of polarization converter 17, whereby this polarization direction becomes the same as that of the first polarized signal 6, whereafter the second polarized optical part-signal with rotated polarization direction 7′ is further processed in the same manner as the first polarized part-signal 6 by means of the passive optical ring resonators 8′,9′,10′ and the active optical ring resonators 14′,15′,16′ and converted by means of a photo diode 17′ into a first electrical signal 18′ which is guided to the same or another electronic appliance (not shown).

Light 21 coming from a light source 20, for instance a laser diode, is split by means of a number of second passive optical ring resonators 22,23,24 into a number of second optical part-signals 25,26,27, each falling within a given wavelength range. Here too, the number of wavelength ranges, in this embodiment three, can be for instance a hundred or more in practice. By means of a number of second active optical ring resonators 28,29,30 the second optical part-signals 25,26,27 are then separately modulated by second electrical signals 19,19′,19″ coming from one or more electronic appliances (not shown), and then combined into a third optical signal 34 by means of a number of third passive optical ring resonators 31,32,33. The third optical signal 34 is guided into optical wave-guide 3. It is noted that light source 20 can in principle also be directly modulated.

Particular features of this transceiver are the use of passive and active optical ring resonators for the different optical functions: wavelength-dependent filtering, switching, modulating, multiplexing and de-multiplexing.

The most important advantage is the use of a limited number of optical components. Through the use of the polarization splitter and polarization converter the optical ring resonators can be optimized for one polarization direction. There is the further option of manufacturing the whole or at least a large part of the optical circuit by means of an integrated planar technology.

Such a device is particularly suitable as optical transceiver in a fibre-to-the-home system in respect of its relatively low price, high functionality and small dimensions.

1. A device for receiving, processing and transmitting optical and electrical signals, comprising:
an optical circuit for processing optical signals;
a connection for optically coupling an optical wave-guide such as a glass fibre to the optical circuit;
at least one opto-electrical converter for converting an optical signal into an electrical signal, which opto-electrical converter is coupled optically to the optical circuit and which opto-electrical converter can be coupled electrically to an electronic applicance, and
at least one electro-optical converter for converting an electrical signal into an optical signal, which electro-optical converter is coupled optically to the optical circuit, characterized in that the optical circuit comprises an integrated circuit comprising a plurality of optical ring resonators.

2. The device as claimed in claim 1, characterized in that the device comprises at least one passive optical ring resonator and at least one active optical ring resonator.

3. The device as claimed in claim 1, characterized in that the device also comprises:
at least one polarization splitter, and
at least one polarization converter.

4. A method for manufacturing a device as claimed claim 1, characterized in that the optical circuit is manufactured in at least partly integrated manner by means of a planar technology.

5. A method for receiving, processing and transmitting optical and electrical signals, comprising the steps of:
A. guiding a first optical signal from an optical wave-guide into an optical circuit;
B. splitting the first optical signal into a number of first optical part-signals, each falling within a given wavelength range, by means of a number of first passive optical ring resonators;
C. separately switching at least one of the first optical part-signals by means of a number of first active optical ring resonators;
D. converting at least one of the switched first optical part-signals into a first electrical signal by means of an opto-electrical converter;
E. generating a second optical signal;
F. splitting the second optical signal into a number of second optical part-signals, each falling within a given wavelength range, by means of a number of second passive optical ring resonators;
G. separately modulating at least one of the second optical part-signals by a second electrical signal by means of a number of second active optical ring resonators;
H. combining at least one of the modulated second optical part-signals to form a third optical signal by means of a number of third passive optical ring resonators; and
I. guiding the third optical signal into the optical wave-guide.

6. A method for receiving, processing and transmitting optical and electrical signals, comprising the steps of:
A. guiding a first optical signal from an optical wave-guide into an optical circuit;
B. splitting the first optical signal into a number of first optical part-signals, each falling within a given wavelength range, by means of a number of first passive optical ring resonators;
C. separately switching at least one of the first optical part-signals by means of a number of first active optical ring resonators;
D. converting at least one of the switched first optical part-signals into a first electrical signal by means of an opto-electrical converter;
Q. generating at least one second optical signal;
R. modulating the second optical signal by a second electrical signal;
H. combining at least one of the modulated second optical part-signals to form a third optical signal by means of a number of third passive optical ring resonators; and
I. guiding the third optical signal into the optical wave-guide.

7. The method as claimed in claim 5, characterized in that the method also comprises the steps of:
X. splitting the first optical signal into two polarized optical part-signals by means of a polarization splitter; and
Y. converting the polarization direction of one of the two polarized optical part-signals by means of a polarization converter.
